(19) United States
(12) Patent Application Publication
(10) Pub. No.: US 2009/0049277 A1
(43) Pub. Date: Feb. 19, 2009

(54) SEMICONDUCTOR INTEGRATED CIRCUIT DEVICE

(75) Inventor: Koji Muranishi, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/132,155

(22) Filed: Jun. 3, 2008

(30) Foreign Application Priority Data
Aug. 14, 2007 (JP) 2007-211467

(51) Int. Cl. G06F 9/38

(52) U.S. Cl. 712/207; 712/E09.055

(57) ABSTRACT

A semiconductor integrated circuit device is provided. The operating frequency generating component generates an operating frequency that is a timing that becomes a reference for synchronizing processing between each circuit when the semiconductor integrated circuit operates. The extracting component extracts a critical path that is the slowest path when a data signal propagates between predetermined terminals inside the semiconductor integrated circuit. The instruction prefetch executing component prefetches an instruction relating to the critical path that has been extracted by the extracting component. The processing configuration changing component changes the processing configuration so as to realize transmission of the data signal within a predetermined cycle of the operating frequency using the instruction prefetch executing component when the data signal passes through the path of the critical path.

### CROSS-REFERENCE TO RELATED APPLICATION

This application claims priority under 35 USC 119 from Japanese Patent Application No. 2007-211467, the disclosure of which is incorporated by reference herein.

### BACKGROUND OF THE INVENTION

1. Field of the Invention

The present invention relates to a semiconductor integrated circuit device and particularly to control of a critical path of a microcontroller.

2. Description of the Related Art

Conventionally, a microcontroller is configured by a clock generating circuit, a central processing unit (called a “CPU” below), a memory controller, a memory and a regulator. A microcontroller is a type of microprocessor where a computer system is incorporated into one integrated circuit, and a microcontroller is optimized for controlling electronic devices. In comparison to a general-purpose microprocessor that is used in a personal computer, a microcontroller can be said to be a type of microprocessor that emphasizes self-sufficiency and cost-effectiveness.

The regulator regulates a voltage on the basis of a power supply voltage that has been supplied from the outside and supplies the regulated voltage to each circuit (the clock generating circuit, the CPU, the memory controller and the memory). Further, the clock generating circuit generates a clock signal on the basis of a clock signal that has been inputted from the outside and supplies the generated clock signal to each circuit (the regulator, the CPU, the memory controller and the memory).

The CPU performs instruction fetch (where the CPU reads a program that is stored in the memory via the memory controller that receives an instruction from the CPU and returns a response) in order to execute processing on the basis of a determined program.

Additionally, because instruction fetch is executed from the CPU, the memory controller accesses (read-accesses) the memory in order to read data from the memory and reads data that are stored in a designated address.

Further, the memory controller receives the data that have been read and returns the data to the CPU, and the CPU executes a program on the basis of the data that have been received from the memory controller. It will be noted that an instruction code (an instruction opcode) is stored in the data that the CPU has received by instruction fetch so that the CPU can discriminate the instruction that the CPU is to execute.

Incidentally, there has been proposed a configuration that variably controls a clock frequency that causes a microprocessor to operate in response to an instruction code such that the processing time of the microprocessor is not determined by the operating time of a critical path (see Japanese Patent Application Publication (JP-A) No. 8-161286).

However, in order to prevent a malfunction resulting from a delay in a data signal in the critical path, it is necessary for the configuration to be a configuration that transmits, within one cycle of the clock frequency (also called an “operating frequency” or simply a “clock”), the data signal that passes through the critical path.

For example, when just the critical path can be caused to operate only at a clock frequency of 30 MHz and circuits other than the critical path operate at a clock frequency of 50 MHz, then the clock frequency of 30 MHz becomes the highest frequency and all of the circuits must be caused to operate at that clock frequency of 30 MHz.

It is also conceivable to lower the clock frequency just when the data signal passes through the critical path, but in this case, it is necessary to protect the switching sequence of the clock frequency with software, and the performance of the entire circuit is lowered by an extra instruction for performing switching of the clock frequency.

Further, a method that delays the response with a multicycle system in just the critical path is also conceivable, but at present, there are many instances where intellectual property (IP) is appropriated to do circuit design, so when IP internals are changed, the number of design/verification man-hours accompanying internal function change becomes enormous.

Moreover, it is possible to reduce delays such as a delay of an element of a path that passes through the critical path and a wiring delay by always applying a high voltage, but a large amount of power is consumed by supplying a high voltage.

### SUMMARY OF THE INVENTION

In view of the above-described circumstances, it is an object of the present invention to obtain a semiconductor integrated circuit device that can prevent a malfunction resulting from a delay in a data signal on a critical path.

A first aspect of the present invention is a semiconductor integrated circuit device comprising: an operating frequency generating component that generates an operating frequency that is a timing that becomes a reference for synchronizing processing between each circuit when the semiconductor integrated circuit operates; an extracting component that extracts a critical path that is the slowest path when a data signal propagates between predetermined terminals inside the semiconductor integrated circuit; an instruction prefetch executing component that prefetches an instruction relating to the critical path that has been extracted by the extracting component; and a processing configuration changing component that changes the processing configuration so as to realize transmission of the data signal within a predetermined cycle of the operating frequency using the instruction prefetch executing component when the data signal passes through the path of the critical path.

A second aspect of the present invention is a critical path control method in a semiconductor integrated circuit device comprising: (a) generating an operating frequency that is a timing that becomes a reference for synchronizing processing between each circuit when the semiconductor integrated circuit operates; (b) extracting a critical path that is the slowest path when a data signal propagates between predetermined terminals inside the semiconductor integrated circuit; (c) prefetching, with an instruction prefetch executing component, an instruction relating to the critical path that has been extracted; and (d) changing the processing configuration so as to realize transmission of the data signal within a predetermined cycle of the operating frequency using the instruction prefetch executing component when the data signal passes through the path of the critical path.

### BRIEF DESCRIPTION OF THE DRAWINGS

FIG. 1 is a configural diagram showing a microcontroller in a first embodiment of the present invention;

FIG. 2 shows a read data example during instruction fetch in the first embodiment of the present invention;

FIG. 3 shows a read data rdata1 example during instruction fetch in the first embodiment of the present invention;

FIG. 4 shows a circuit example of a critical path in the first embodiment of the present invention;

FIG. 5 shows a circuit diagram of an instruction prefetch circuit in the first embodiment of the present invention;

FIG. 6 shows a circuit diagram of a clock mask circuit in the first embodiment of the present invention;

FIG. 7 shows a time chart in the first embodiment of the present invention;

FIG. 8 shows a time chart via the critical path when the first embodiment of the present invention is implemented;

FIG. 9 is a configural diagram showing a second embodiment of the present invention;

FIG. 10 shows a circuit diagram of a power supply voltage generating circuit in the second embodiment of the present invention;

FIG. 11 shows a time chart in the second embodiment of the present invention; and

FIG. 12 shows a time chart via the critical path when the second embodiment of the present invention is implemented.

### DETAILED DESCRIPTION OF THE INVENTION

### First Embodiment of the Present Invention

Below, a first embodiment of the present invention will be described.

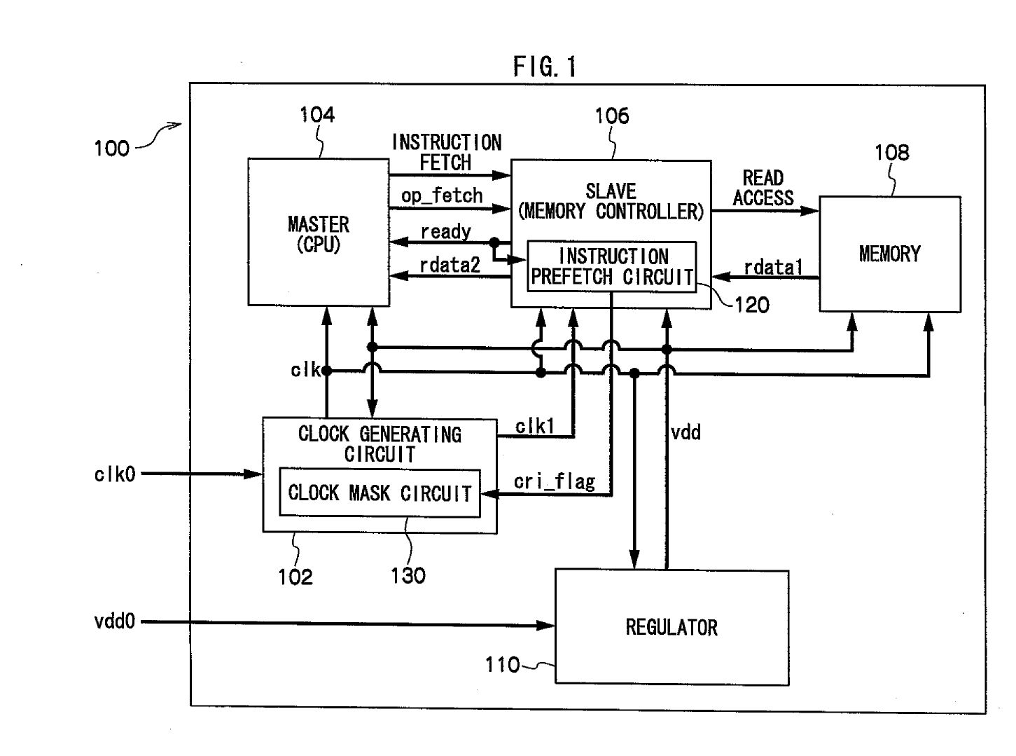

FIG. 1 is a configural diagram showing a microcontroller 100 in the first embodiment of the present invention.

The microcontroller 100 is configured by a clock generating circuit 102, a master 104, a slave 106, a memory 108 and a regulator 110.

The clock generating circuit 102 is configured to include a clock mask circuit 130 (a processing configuration changing component) and includes the function of supplying, to each block inside the microcontroller 100, a clock clk0 signal that is supplied from the outside of the microcontroller 100. It will be noted that the clock clk0 signal (also including other clock signals) is a signal that represents a tempo for synchronizing processing between each circuit inside a computer or between each element of each circuit, and the speed of this clock clk0 signal (also including other clock signals) is called a clock frequency (also called an “operating frequency” or simply a “clock”). It will be noted that the clock frequency that is an operating frequency is generated by an operating frequency generating component and becomes a timing that becomes a reference for synchronizing processing between each circuit when the semiconductor integrated circuit operates.

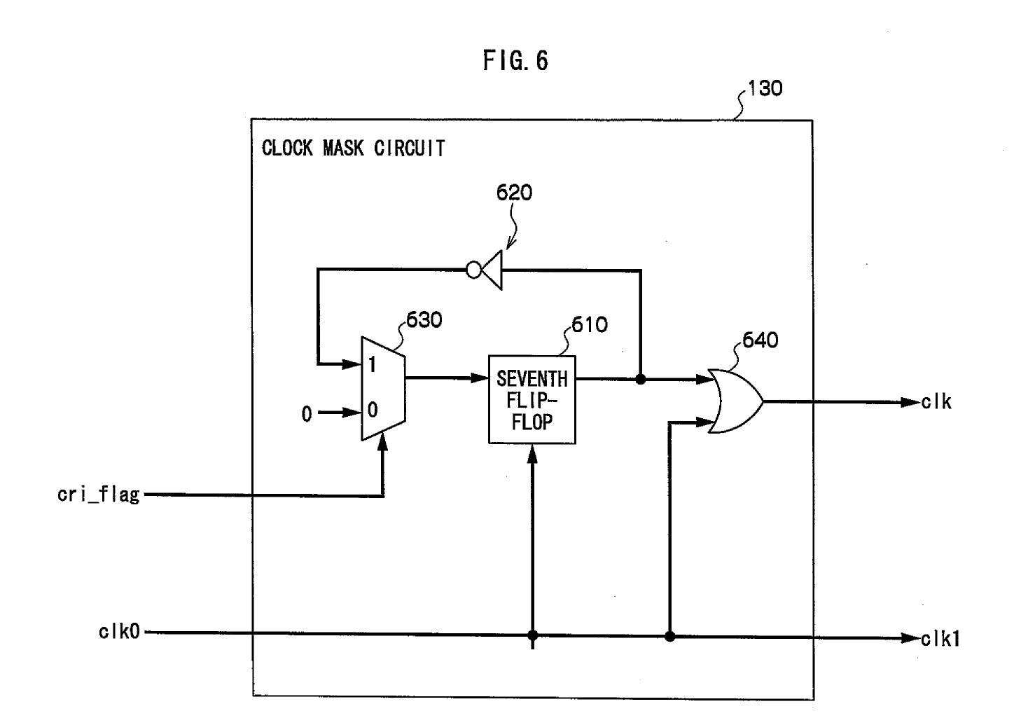

The clock mask circuit 130 will be described in detail later using FIG. 6.

The master 104 is configured by a CPU, for example, and includes the function of performing processing in accordance with a determined program (which is stored in the memory 108 or the like). It will be noted that the master 104 is not limited to a CPU as long as it outputs an instruction for data processing.

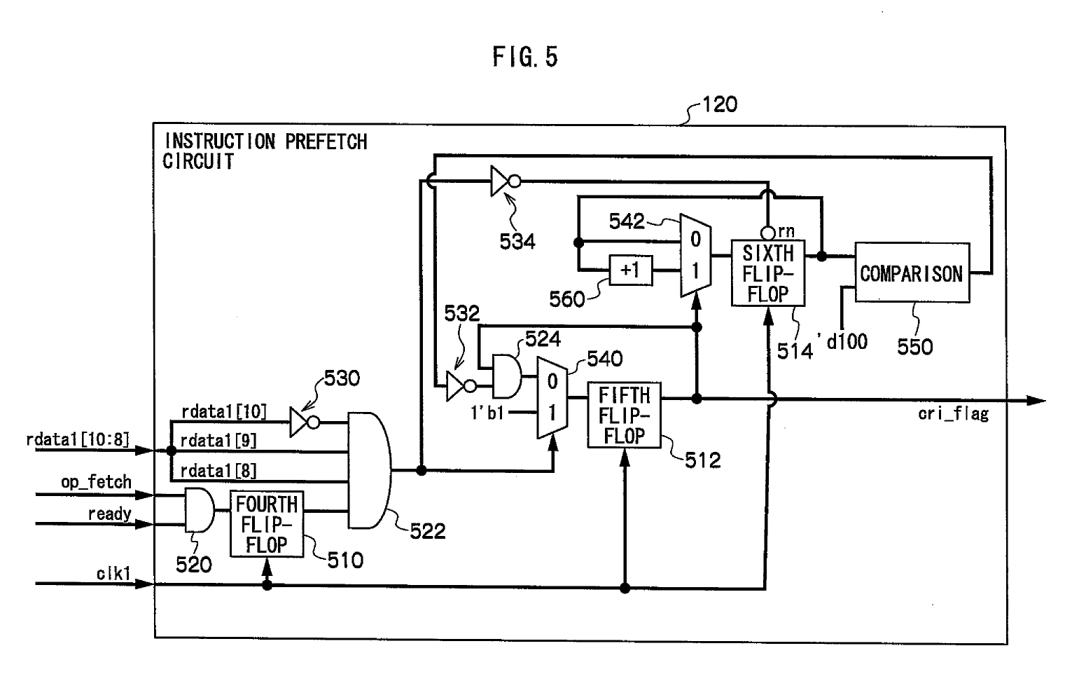

The slave 106 is configured to include an instruction prefetch circuit 120 (an instruction prefetch executing component) as a memory controller, for example, and includes the function of receiving an access signal from the master 104 and returning a response. It will be noted that the slave 106 may also be a system controller and may also employ a system such as direct memory access (DMA). The instruction prefetch circuit 120 will be described in detail later using FIG. 5.

The memory 108 is a device (a storage place) that stores data and programs.

The regulator 110 includes the function of supplying, to each circuit block (the clock generating circuit 102, the master 104, the slave 106 and the memory 108) inside the microcontroller 100, a power supply voltage Vdd0 that is supplied from the outside of the microcontroller 100. It will be noted that the regulator 110 is also called a power supply stabilizer or a transformer in computer systems. Specifically, in the present invention, a three-terminal regulator is used for the regulator 110, and the regulator 110 is a voltage rectifier that has three terminals (an input terminal, a ground terminal and an output terminal) and smoothes a direct current power supply that has been inputted thereto into a constant current and outputs the constant current.

To describe in detail, the clock generating circuit 102 is connected to the master 104, the slave 106, the memory 108 and the regulator 110, and a clock clk signal that is outputted from the clock generating circuit 102 is transmitted to the master 104, the slave 106, the memory 108 and the regulator 110. Further, the regulator 110 is connected to the clock generating circuit 102, the master 104, the slave 106 and the memory 108, and a power supply voltage Vdd that is outputted from the regulator 110 is supplied to the clock generating circuit 102, the master 104, the slave 106 and the memory 108.

The microcontroller 100 operates by a predetermined sequence. It will be noted that “sequence” means sequential control and is control where each stage of control sequentially advances in accordance with a predetermined order or procedure, so terminology used at each stage at that time will be described in advance.

(Instruction Fetch, op_fetch Signal and Ready Signal)

The master 104 performs instruction fetch (where it fetches from a memory an instruction code that a processor is to process and forwards the instruction code to a register) in order to execute a program that the master 104 is to execute. Further, the master 104 outputs, to the slave 106, an op_fetch signal indicating that instruction fetch is being executed. Then, the slave 106 receives the instruction that the master 104 has issued and a ready signal indicating that the master 104 can execute the next instruction. Specifically, this instruction fetch access is where the master 104 reads, via the slave 106, a program that is stored in the memory 108.

(Read Access)

When instruction fetch is executed from the master 104, the slave 106 performs read-access (access for reading desired data) with respect to the memory 108.

(Read Data rdata1)

The memory 108 outputs read data rdata1, which are data stored in an address corresponding to read access from the slave 106, and the slave 106 receives the read data rdata1.

(Read Data rdata2)

When the slave 106 receives the read data rdata1 from the memory 108, the slave 106 transmits read data rdata2 to the master 104.

(Clock clk1 Signal)

A clock clk1 signal is a clock (a clock signal) that is supplied from the clock mask circuit 130 and causes the instruction prefetch circuit 120 to operate.

(cri_flag Signal)

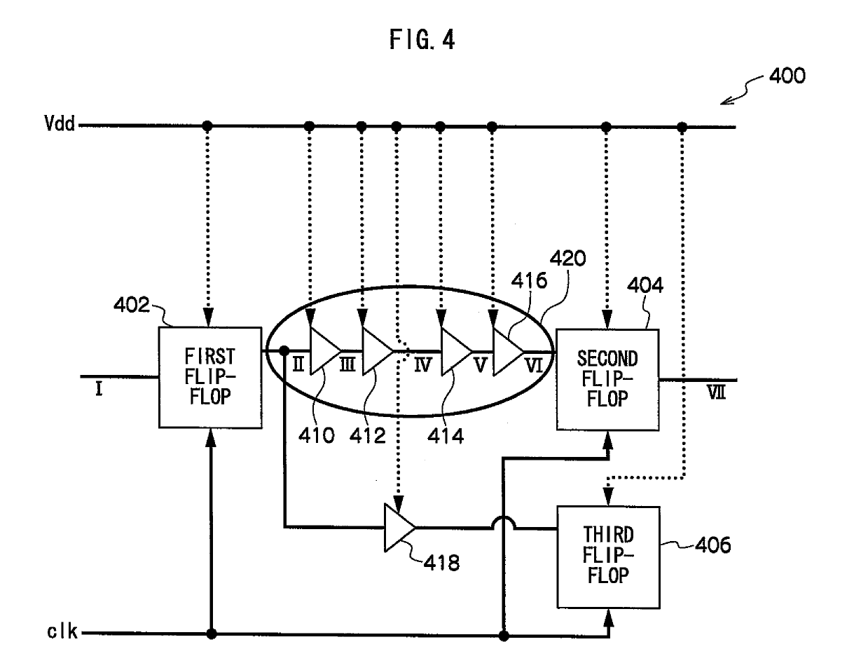

A cri_flag signal is a signal that is outputted from the instruction prefetch circuit 120 and indicates that an instruction that passes through a critical path 420 (FIG. 4) is predicted (identified) in advance and will be executed in the future. It will be noted that, although an instruction that passes through the critical path 420 is predicted (identified) in advance, it may also be a result obtained by doing a simulation using a computer or the like, and any means may be used as long as there are means that can identify an instruction that passes through the critical path 420.

(Instruction Execution)

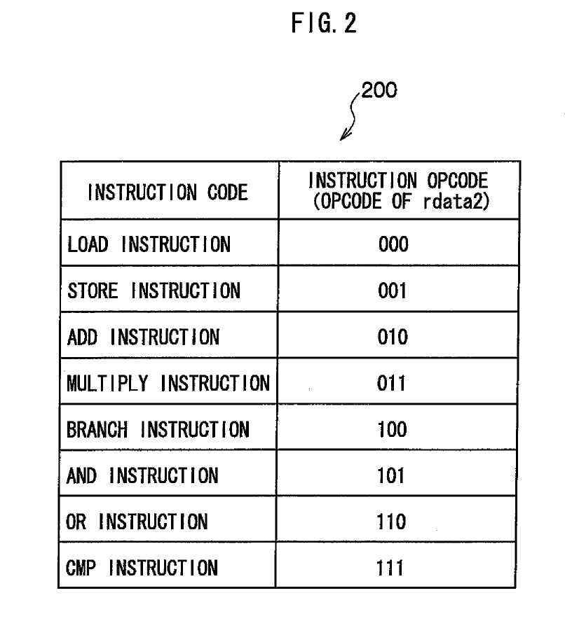

The master 104 executes a program on the basis of the read data rdata2 that have been received from the memory 108 via the slave 106. Specifically, in the read data rdata2 that the master 104 has received on the basis of the instruction fetch, the op_fetch signal and the ready signal that the master 104 has transmitted to the slave 106, there is stored an instruction code (an instruction opcode of FIG. 2) so that the master 104 can discriminate the instruction that the master 104 is to execute. Additionally, the master 104 executes a program on the basis of the instruction code that is stored in the read data rdata2 and the ready signal that is transmitted from the slave 106.

In FIG. 2, there is shown a read data example 200 during instruction fetch in the first embodiment of the present invention.

In the read data during instruction fetch, there are stored data such as instruction codes and instruction opcodes shown in FIG. 2.

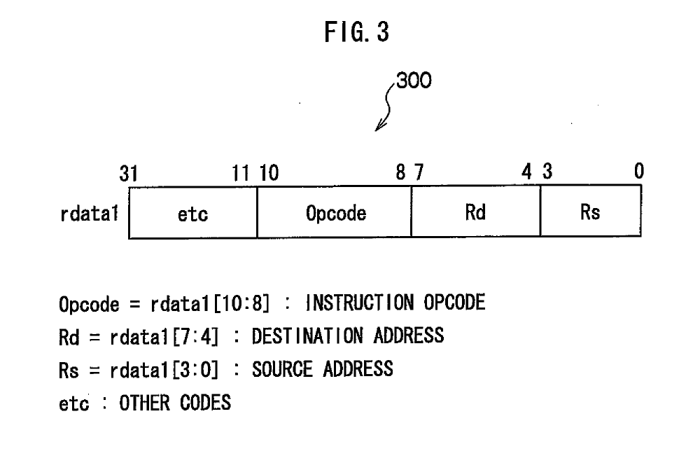

An instruction opcode is a code where an instruction that the master 104 is to execute is coded, and is stored from the eighth bit place to the tenth bit place in the read data rdata1 (refer to instruction opcode example 300 of FIG. 3).

Relationships between instruction codes and instruction opcodes are indicated such that, for example, an instruction code load instruction is instruction opcode “000” and an instruction code store instruction is instruction opcode “001”.

It will be noted that, in the other bits, there are stored a source address and a destination address that are used when the master 104 executes an instruction.

In FIG. 3, there is shown a read data rdata1 example 300 during instruction fetch in the first embodiment of the present invention.

The read data rdata1 example 300 during instruction fetch is an example to which the instruction shown in the instruction opcode (opcode of rdata2) of FIG. 2 has been corresponded.

The master 104 executes a program in accordance with the read data rdata2 that have been received by instruction fetch. At that time, depending on the type of instruction, there is present an instruction that passes through the critical path 420.

The critical path 420 is a path that takes the most time in the propagation of a signal, and is a path that limits circuit operation. The critical path 420 is extracted by an extracting component and predicted (identified) in advance, but it may also be a result obtained by doing a simulation using a computer or the like, and any means may be used as long as there are means that can identify the critical path 420.

Consequently, the highest clock frequency (the highest operating frequency) that represents the performance of the operation of the microcontroller 100 is determined by this critical path 420. Sometimes a gate delay or a wiring delay occurs in the propagation of a signal.

A gate delay is a delay that occurs when a signal passes through a gate of an AND circuit or the like. A wiring delay is a delay of a timing when a signal propagates in a wire, and a delay in the transmission of a signal that occurs in a wire that interconnects transistors as a result of miniaturization advancing and transistor performance speeding up to an utmost limit becomes a contributing factor that hinders the raising of the performance of the entire microcontroller 100.

Additionally, from the zero bit place to the third bit place represents a source address Rs (an address that serves as a reference of data to be used in processing) and is expressed as rdata1[3:0]. Further, from the fourth bit place to the seventh bit place represents a destination address Rd (an address that serves as a storage destination of a processing result) and is expressed as rdata1[7:4]. Moreover, from the eighth bit place to the tenth bit place represents an opcode (instruction opcode) and is expressed as rdata1[10:8]. Further; from the eleventh bit place to the thirty-first bit place represents other codes etc. and is expressed as rdata[31:11]. In this manner, the read data rdata1 example 300 during instruction fetch is represented by a 32-bit path configuration expressed by codes of “0” and “1”.

In FIG. 4, there is shown a circuit example 400 of the critical path 420 in the first embodiment of the present invention.

A first flip-flop circuit 402, a second flip-flop circuit 404 and a third flip-flop circuit 406 operate by the rising edge of the clock clk signal generated by the clock generating circuit 102.

The first flip-flop circuit 402 is connected to the second flip-flop circuit 404 via four buffers 410, 412, 414 and 416.

A signal I is inputted to the first flip-flop circuit 402, a signal VI is inputted to the second flip-flop circuit 404 via the four buffers 410, 412, 414 and 416, and the second flip-flop circuit 404 outputs a signal VII.

The third flip-flop circuit 406 and the first flip-flop circuit 402 are interconnected via one buffer 418.

Specifically, a signal II that is outputted from the first flip-flop circuit 402 is inputted to the buffer 410, and the buffer 410 outputs a signal III. The buffer 412, to which the signal III has been inputted, outputs a signal IV. The buffer 414, to which the signal IV has been inputted, outputs a signal V. Then, the buffer 416, to which the signal V has been inputted, outputs the signal VI, and the second flip-flop circuit 404, to which the signal VI has been inputted, outputs the signal VII.

The clock clk signal is inputted to the first flip-flop circuit 402, the second flip-flop circuit 404 and the third flip-flop circuit 406, and is used as a synchronizing signal. Further, the power supply voltage Vdd is respectively supplied to each circuit (the first flip-flop circuit 402, the second flip-flop circuit 404, the third flip-flop circuit 406 and the buffers 410, 412, 414, 416 and 418).

Here, it is assumed that the critical path 420 in this circuit is the path between the first flip-flop circuit 402 and the second flip-flop circuit 404.

All of these cells (cells of the first flip-flop circuit 402, the second flip-flop circuit 404, the third flip-flop circuit 406 and the buffers 410, 412, 414, 416 and 418) operate by the power supply voltage Vdd. A cell is a minimum unit that expresses the function of a semiconductor when designing a semiconductor integrated circuit.

In FIG. 5, there is shown a circuit diagram of the instruction prefetch circuit 120 in the first embodiment of the present invention.

The op_fetch signal, the ready signal, the clock clk1 signal supplied from the clock mask circuit 130 and the read data rdata1 from the memory 108 are inputted to the instruction prefetch circuit 120, and the cri_flag signal is outputted from the instruction prefetch circuit 120.

A fourth flip-flop circuit 510, a fifth flip-flop circuit 512 and a sixth flip-flop circuit 514 of the instruction prefetch circuit 120 operate by the rising edge of the clock clk1 signal.

The output of a first AND circuit 520 is connected to the input of the fourth flip-flop circuit 510, and the output of the fourth flip-flop circuit 510 is connected to the input of a second AND circuit 522.

An output signal of the first AND circuit 520, to which the op_fetch signal and the ready signal are inputted, is transmitted to the second AND circuit 522 via the fourth flip-flop circuit 510.

Read data rdata1[10] are inputted from the outside of the instruction prefetch circuit 120 to the second AND circuit 522 via an inverter 530. Read data rdata1[9] and read data rdata1[8] are inputted from the outside of the instruction prefetch circuit 120 to the second AND circuit 522. Moreover, the output of the second AND circuit 522 is connected to the input of a first selector circuit 540 and to the input of an inverter 534.

That is, inputted to the second AND circuit 522 are the output signal of the fourth flip-flop circuit 510, a signal where the tenth bit place of the read data rdata1 has been inverted by the inverter 530, the signal of the ninth bit place of the read data rdata1 and the signal of the eighth bit place of the read data rdata1.

The output signal of the second AND circuit 522 is transmitted as a select signal of the first selector circuit 540 (a control signal for selectively controlling the output signal of the first selector circuit 540) and as an input signal of the inverter 534.

It will be noted that, as for the value of the read data rdata1 inputted to the second AND circuit 522, the data of instruction fetch represent a multiply instruction (“011” in FIG. 2) of the instruction that passes through the critical path 420 (precondition).

The output of the second AND circuit 522, 1'b1 (binary “1” of one bit) and the output of a third AND circuit 524 are connected to the first selector circuit 540. Further, the output of the first selector circuit 540 is connected to the input of the fifth flip-flop circuit 512, and a second selector circuit 542 and the third AND circuit 524 are connected to the output of the fifth flip-flop circuit 512.

The output signal of the first selector circuit 540 is inputted to the fifth flip-flop circuit 512. When the select signal inputted to the first selector circuit 540 is “H”, then the output signal of the first selector circuit 540 becomes “H” (1'b1). When the select signal inputted to the first selector circuit 540 is “L”, then the output signal of the first selector circuit 540 becomes the output signal of the third AND circuit 524.

It will be noted that the output signal of the fifth flip-flop circuit 512 is outputted from the instruction prefetch circuit 120 as the cri_flag signal and is transmitted as the input signal of the third AND circuit 524 and as the select signal of the second selector circuit 542.

The output of the fifth flip-flop circuit 512, the output of a counter circuit 560 and the output of the sixth flip-flop circuit 514 are connected to the second selector circuit 542. The output of the inverter 534 is connected to the input of the sixth flip-flop circuit 514 via an asynchronous reset terminal (negative reset terminal) m, and the output of the second selector circuit 542 is also connected to the input of the sixth flip-flop circuit 514. The output of the sixth flip-flop circuit 514 is connected to the input of the second selector circuit 542, the input of the counter circuit 560 and the input of a comparison circuit 550. Additionally, in the comparison circuit 550, the output of the sixth flip-flop circuit 514 and 'd100 (decimal digits “100”) are inputted. The output of the comparison circuit 550 is connected to the input of the third AND circuit 524 via the inverter 532.

The output signal of the second selector circuit 542 is inputted to the sixth flip-flop circuit 514. When the select signal inputted to the second selector circuit 542 is “H”, then the output signal of the second selector circuit 542 a value equal to the output signal of the sixth flip-flop circuit 514 plus one by the counter circuit 560. Further, when the select signal inputted to the second selector circuit 542 is “L”, then the output signal of the second selector circuit 542 becomes the output signal of the sixth flip-flop circuit 514.

An asynchronous reset signal (a negative reset signal representing inversion reset) is inputted to the sixth flip-flop circuit 514 via the inverter 534 and the negative reset terminal m, and performs resetting. Further, the comparison circuit 550 is a circuit that compares the output signal of the sixth flip-flop circuit 514 and the fixed decimal digits “100”, outputs an output signal of “H” when the value of the output of the sixth flip-flop circuit 514 has become 100 and outputs “L” in other cases. Specifically, when the value of the sixth flip-flop circuit 514 has become 100 and the output signal has become “H”, then the value of the sixth flip-flop circuit 514 is reset, and when the output signal is “L”, then the value of the sixth flip-flop circuit 514 continues to be counted in increments of +1.

The clock clk signal is inputted to the fourth flip-flop circuit 510, the fifth flip-flop circuit 512 and the sixth flip-flop circuit 514 such that these flip-flop circuits operate synchronously.

In regard to the asynchronous reset signal, first, it is triggered when the pulse of the second AND circuit 522 rises and it asynchronously applies a reset.

It will be noted that, although that the read data rdata1[10:8] is a multiply instruction “011” is used as a precondition, this has been selected because it is fastest when a multiply instruction passes through the critical path 420. Consequently, when the instruction that passes through the critical path 420 is not a multiply instruction, for example, in the case of an AND instruction “101”, there is no inverter 530 in the place where the read data rdata1[10] are inputted, and the inverter 530 is disposed in the place where the read data rdata[9] are inputted. As mentioned above, in the critical path 420, a certain place is understood on the basis of conditions such as what kind of instruction takes time and how many times it is involved, and for the first time, a situation where a delay in a terminal or a wire becomes larger becomes a precondition, so there are also cases where the multiply instruction such as in the present invention does not become a precondition.

In FIG. 6, there is shown a circuit diagram of the clock mask circuit 130 in the first embodiment of the present invention.

The output (cri_flag signal) from the instruction prefetch circuit 120, a fixed value of “0” and the output of an inverter 620 are connected as controller signals to a third selector circuit 630. Further, the output of the third selector circuit 630 is connected to the input of a seventh flip-flop circuit 610. The output of the seventh flip-flop circuit 610 is connected to the input of the inverter 620 and to the input of an OR circuit 640. The clock clk0 signal is connected from the outside of the microcontroller 100 to the input of the seventh flip-flop circuit 610 and to the input of the OR circuit 640.

The clock clk0 signal that is supplied from the outside of the microcontroller 100 and the cri_flag signal that is the output signal from the instruction prefetch circuit 120 are inputted to the clock mask circuit 130. The clock mask circuit 130 outputs the clock clk1 signal that causes the instruction prefetch circuit 120 to operate. Moreover, the clock mask circuit 130 outputs the clock clk signal that causes the master 104, the slave 106, the memory 108 and the regulator 110 to operate.

The input signal cri_flag signal is transmitted as a select signal of the third selector circuit 630.

When the select signal (cri_flag signal) is “0”, then the output of the third selector circuit 630 is fixed at “0”. When the select signal (cri_flag signal) is “1”, then the output signal of the inverter 620 is selected for the output signal of the third selector circuit 630.

The output signal of the seventh flip-flop circuit 610 is transmitted to the third selector circuit 630 via the inverter 620. Further, the output signal of the seventh flip-flop circuit 610 is inputted as the input signal of the OR circuit 640. It will be noted that an initial value of “0” is held in the seventh flip-flop circuit 610 because the clock clk0 signal enters the seventh flip-flop circuit 610 from the outside of the microcontroller 100.

The clock clk0 signal is inputted to another input of the OR circuit 640, and an output signal is outputted from the clock mask circuit 130 as the clock clk signal. It will be noted that, as for the other output signal clock clk1 signal, the clock clk0 signal is transmitted as is (clock clk1 signal=clock clk0 signal).

Below, the action of the first embodiment of the present invention will be described.

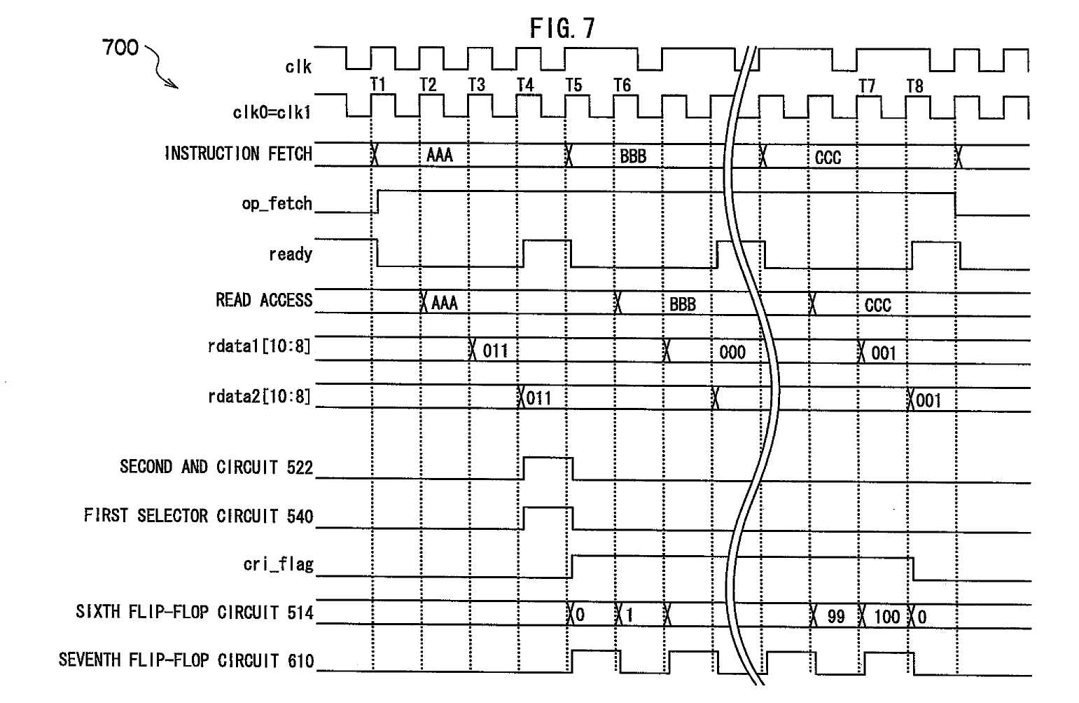

In FIG. 7, there is shown a time chart 700 in the first embodiment of the present invention.

In the first embodiment of the present invention, it is assumed that a multiply instruction passes through the critical path 420 (precondition).

At time T1, instruction fetch AAA is executed from the master 104. At this time, the signal op_fetch signal representing instruction fetch becomes “H”. It will be noted that the ready signal changes from “H” to “L” at the same time.

At time T2, read access occurs from the slave 106 with respect to the memory 108. At time T3, the read data rdata1 are outputted from the memory 108, and the slave 106 receives the read data rdata1. The instruction at this time is a multiply instruction “011” in the critical path 420.

At time T4, the read data rdata2 are outputted from the slave 106 with respect to the master 104. At the same time, the second AND circuit 522 and the first selector circuit 540 of the instruction prefetch circuit 120 and the ready signal become “H” (become a trigger).

At time T5, the output signals of the second AND circuit 522 and the first selector circuit 540 of the instruction prefetch circuit 120 become “L”, and the fifth flip-flop circuit 512 of the instruction prefetch circuit 120 becomes “H”, so the cri_flag signal also becomes “H”, and the sixth flip-flop circuit 514 starts counting up from 0. Specifically, at time T4, the “H” signal of the second AND circuit 522 becomes a trigger pulse and counting starts. Further, the cri_flag signal becomes “H”, whereby the seventh flip-flop circuit 610 of the clock mask circuit 130 also becomes “H” and masks every one cycle in accordance with the rise of the clock clk0 signal (=clock clk1 signal). Moreover, the master 104 outputs the next instruction BBB instruction fetch.

At time T6, the cycle of the clock clk1 signal (clock clk0 signal) that is the normal clock frequency becomes slower and is changed to the clock clk signal that has dropped to half the speed of the normal clock frequency so as to not cause a malfunction even when the instruction passes through the critical path 420.

At time T7, the sixth flip-flop circuit 514 of the instruction prefetch circuit 120 becomes 'd100 (decimal digits “100”), and the input signal of the fifth flip-flop circuit 512 of the instruction prefetch circuit 120 becomes “L”.

At time T8, the fifth flip-flop circuit 512 of the instruction prefetch circuit 120 becomes “L”, so the cri_flag signal also becomes “L”, and the clock clk signal that had been changed to half the speed of the normal clock frequency returns to the normal clock frequency and operates.

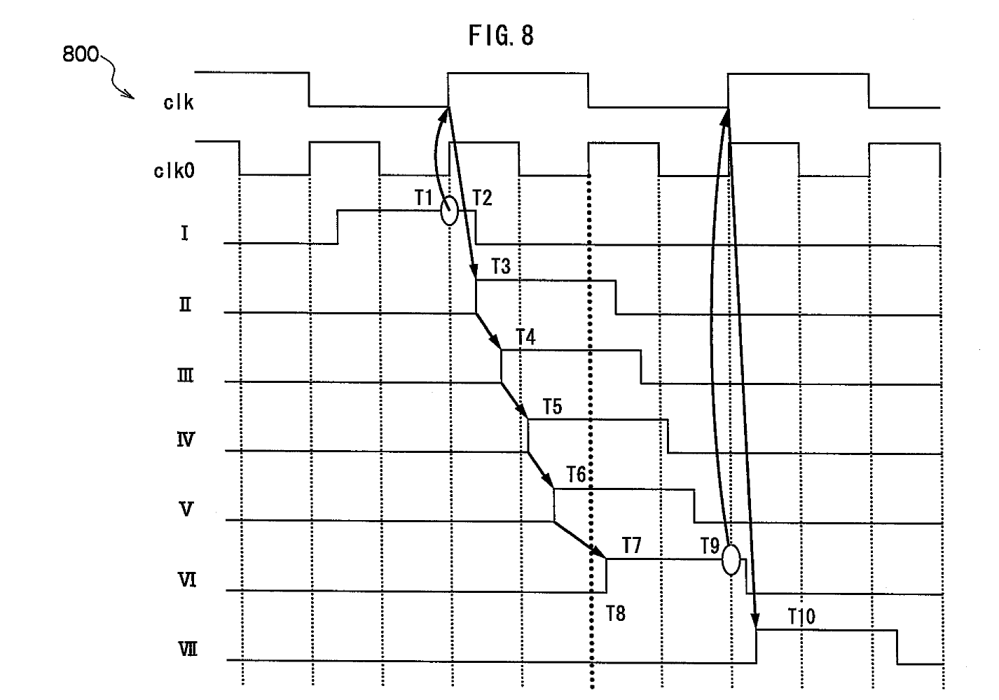

In FIG. 8, there is shown a time chart 800 via the critical path 420 when the first embodiment of the present invention is implemented.

The time chart 800 is a time chart of the circuit of FIG. 4.

At (elapse 1-1) time T1, the signal I of the first flip-flop circuit 402 changes to “1” by the rise of the clock clk signal.

At (elapse 1-2) time T2, the signal I is held in the first flip-flop circuit 402 by the rise of the clock clk signal.

At (elapse 1-3) time T3, the signal II changes to “1”.

At (elapse 1-4) time T4, the signal III changes to “1”.

At (elapse 1-5) time T5, the signal IV changes to “1”.

At (elapse 1-6) time T6, the signal V changes to “1”.

At (elapse 1-7) time T7, the signal VI changes to “1”.

At (elapse 1-8) time T8, when the signal VI changes to “1”, there is no rising edge of the clock clk signal, so there is no next rising edge of the clock clk signal held in the first flip-flop circuit 402.

At (elapse 1-9) time T9, the input data are held by the rise of the clock clk signal, so the second flip-flop circuit 404 holds the signal VI.

At (elapse 1-10) time T10, the signal VII is outputted as “1”, so the signal propagation time from the first flip-flop circuit 402 to the second flip-flop circuit 404 falls within one cycle that is a predetermined cycle of the clock frequency of the clock clk signal.

Consequently, according to the first embodiment of the present invention, by prefetching the instruction that passes through the critical path 420, the frequency of the clock frequency can be delayed just when the instruction passes through the critical path 420.

Further, even when the highest frequency of the microcontroller 100 must be lowered by the critical path 420, by prefetching the instruction using the instruction prefetch circuit 120, the clock frequency can be delayed by just the period when the instruction passes through that path, and the microcontroller 100 can be operated at an optimum clock frequency as needed.

Moreover, the clock frequency is not delayed by software control beforehand when the instruction passes through the critical path 420, and the clock frequency is controlled by hardware, so the performance of the entire microcontroller 100 can be improved.

Further, when is it necessary to protect the switching sequence of the clock frequency by software, the performance of the entire circuit is lowered by an extra instruction for performing switching of the clock frequency, but in the first embodiment of the present invention, this can be done without lowering the performance of the entire circuit.

Moreover, in a case where the response (clock frequency) is delayed with a multicycle system in just the critical path, when IP is appropriated to do circuit design and IP internals are changed, the number of design/verification man-hours accompanying internal function change becomes enormous, but in the first embodiment of the present invention, such effort can be eliminated.

### Second Embodiment of the Present Invention

Below, a second embodiment of the present invention will be described.

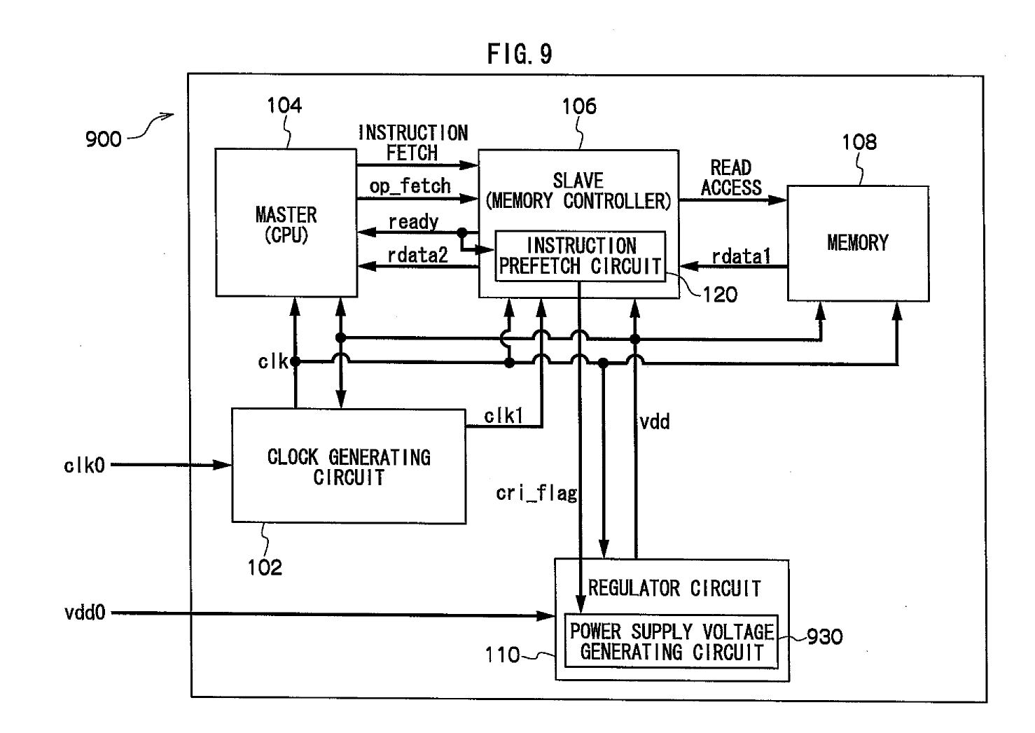

FIG. 9 is a configural diagram showing the second embodiment of the present invention.

The same reference numerals will be given to configurations that are the same as those in the configural diagram of FIG. 1 showing the first embodiment of the present invention.

Further, the instruction prefetch circuit 120 has the same circuit configuration as in the first embodiment and is a circuit that has the same elements as shown in FIG. 5.

Further, the clock clk1 signal that is inputted to the instruction prefetch circuit 120 has the same clock frequency as the clock clk0 signal from the outside of a microcontroller 900 (clock clk0 signal=clock clk1 signal).

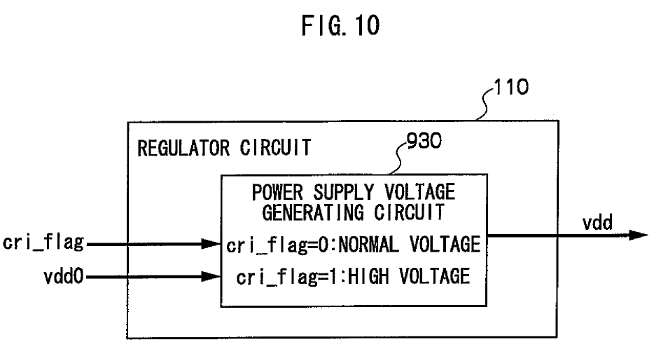

The regulator circuit 110 is different from the regulator circuit 110 of the first embodiment in that the regulator circuit 110 here is configured to include a power supply voltage generating circuit 930 (a processing configuration changing component), and the cri_flag signal is not inputted to the clock mask circuit 130 but to the power supply voltage generating circuit 930. Further, the power supply voltage generating circuit 930 regulates a signal strength level correlated with the rise time of signal propagation. It will be noted that the details of the power supply voltage generating circuit 930 will be described in FIG. 10.

In FIG. 10, there is shown a circuit diagram of the power supply voltage generating circuit 930 in the second embodiment of the present invention.

The cri_flag signal that is outputted from the instruction prefetch circuit 120 and the power supply voltage Vdd0 from the outside are inputted to the power supply voltage generating circuit 930, and the power supply voltage generating circuit 930 includes the function of changing the power supply voltage Vdd that is outputted by the state of the cri_flag signal.

The power supply voltage Vdd that is outputted from the power supply voltage generating circuit 930 is, during normal times (cri_flag signal=“0”=“L”), a voltage (normal voltage) that is the same as conventionally, and becomes a high power supply voltage Vdd (high voltage) when the instruction that passes through the critical path 420 will be executed in the future (cri_flag signal=“1”=“H”).

For example, when the normal voltage is 3.3 V (standard is 3.3 V±0.3 V), then 3.6 V (=3.3 V+0.3 V), which is within the standard, is a high voltage.

Below, the action of the second embodiment of the present invention will be described.

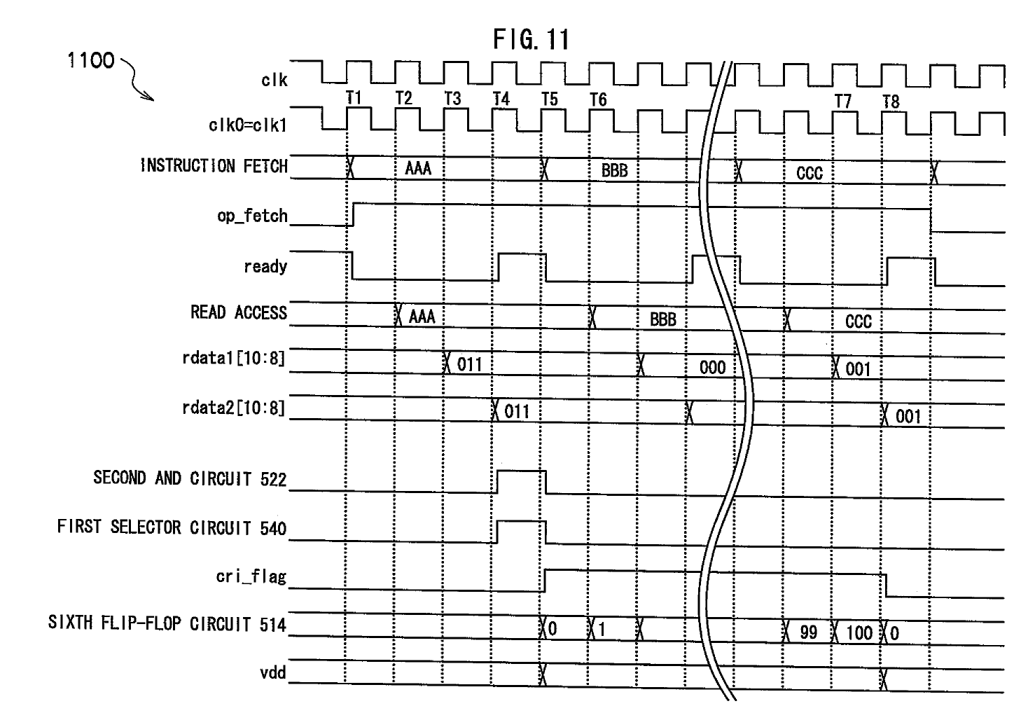

In FIG. 11, there is shown a time chart 1100 in the second embodiment of the present invention. Shared reference numerals are given to elements shown in the drawing that are shared with the elements in FIG. 9 and FIG. 10.

The time chart 1100 is, in comparison to the time chart 700 of the first embodiment in FIG. 7, different in that the clock clk signal that is outputted from a clock generating circuit 102 is not changed in the case of the second embodiment, and operation of the instruction prefetch circuit 120 is no different from operation of the instruction prefetch circuit 120 in the first embodiment.

Further, in comparison to the time chart 700 of the first embodiment in FIG. 7, the time chart 1100 is different in that it shows the state of the power supply voltage of the power supply voltage Vdd rather than the waveform of the seventh flip-flop circuit 610.

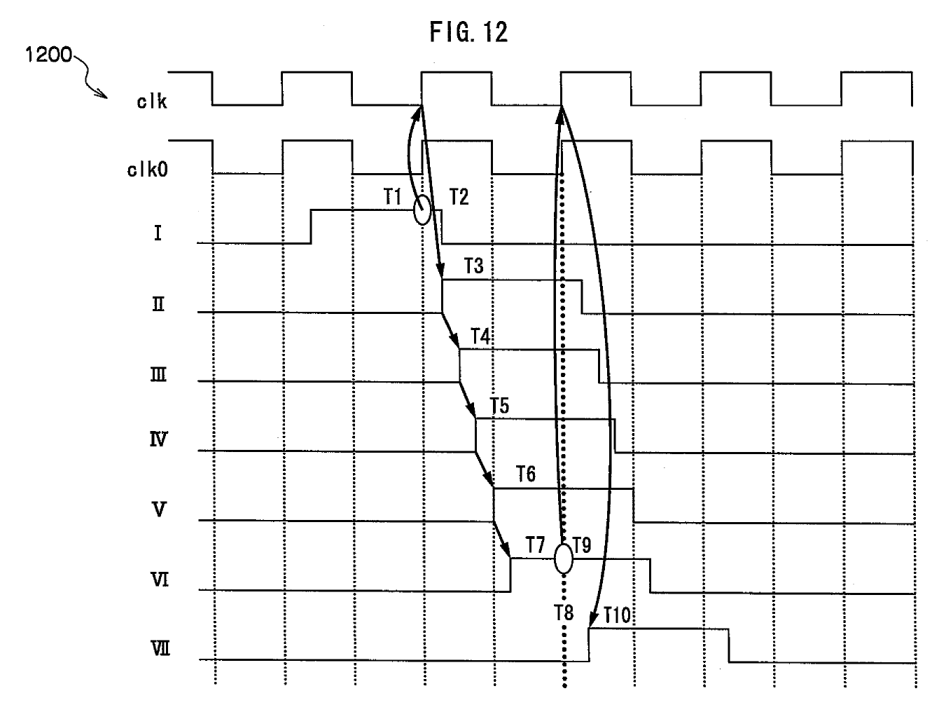

In FIG. 12, there is shown a time chart 1200 via the critical path 420 when the second embodiment of the present invention is implemented.

The time chart 1200 is a time chart of the circuit of FIG. 4.

According to the second embodiment during the period when the cri_flag signal is “H” (high voltage period), the power supply voltage Vdd that is supplied is high, so the period becomes smaller in comparison to the terminal delay of all the cells of FIG. 4.

At (elapse 2-1) time T1, the signal I of the first flip-flop circuit 402 changes to “1” by the rise of the clock clk signal.

At (elapse 2-2) time T2, the signal I is held in the first flip-flop circuit 402 by the rise of the clock clk signal.

At (elapse 2-3) time T3, the signal II changes to “1”.

At (elapse 2-4) time T4, the signal III changes to “1”.

At (elapse 2-5) time T5, the signal IV changes to “1”.

At (elapse 2-6) time T6, the signal V changes to “1”.

At (elapse 2-7) time T7, the signal VI changes to “1”.

At (elapse 2-8) time T8, when the signal VI changes to “1”, the clock frequency of the clock clk signal held in the first flip-flop circuit 402 receives the data signal of the signal VI because there is a next rising edge.

At (elapse 2-9) time T9, the second flip-flop circuit 404 holds the signal VI.

At (elapse 2-10) time T10, the signal VII becomes “1”, so the signal propagation time from the first flip-flop circuit 402 to the second flip-flop circuit 404 falls within one cycle that is a predetermined cycle of the clock frequency of the clock clk signal.

Consequently, according to the second embodiment of the present invention, by prefetching the instruction that takes the critical path 420 by the instruction prefetch circuit 120 and raising the supply voltage (from a normal voltage to a high voltage) just when the instruction passes through the critical path 420, terminal delays and wiring delays can be reduced by the power of the high voltage.

Further, even when the highest frequency of the microcontroller 900 must be lowered by the critical path 420, by prefetching the instruction using the instruction prefetch circuit 120, the supplied voltage can be raised just during the period when the instruction passes through that path, and the microcontroller 900 can be operated at an optimum voltage as needed.

Moreover, it is not necessary to delay the clock frequency by software control beforehand when the instruction passes through the critical path 420, and the voltage is controlled by hardware, so it becomes possible to improve the performance of the entire microcontroller 900.

Further, a high voltage is supplied just when the critical path 420 is taken, so this can contribute to lowering power consumption.

Moreover, a high voltage is supplied just when the critical path 420 is taken, so the microcontroller 900 can be operated without having to lower the highest frequency of the clock frequency.

Further, when it is necessary to protect the switching sequence of the clock frequency with software, this can be done without the performance of the entire circuit being lowered by an extra instruction for performing switching of the clock frequency.

Moreover, in a case where the response (e.g., the clock frequency of the clock clk signal) is delayed with a multicycle system in just the critical path, when IP is appropriated to do circuit design and IP internals are changed, the number of design/verification man-hours accompanying internal function change becomes enormous, but in the second embodiment of the present invention, such effort can be eliminated.

In the first and second embodiments of the present invention, it was assumed that there was one instruction that passes through the critical path 420 (in the present invention, at the time of a multiply instruction), but even when there are one or more instructions that pass through the critical path 420, the same effects can be obtained by changing the logic of the instruction prefetch circuit 120.

An aspect of the present invention is a semiconductor integrated circuit device comprising: an operating frequency generating component that generates an operating frequency that is a timing that becomes a reference for synchronizing processing between each circuit when the semiconductor integrated circuit operates; an extracting component that extracts a critical path that is the slowest path when a data signal propagates between predetermined terminals inside the semiconductor integrated circuit; an instruction prefetch executing component that prefetches an instruction relating to the critical path that has been extracted by the extracting component; and a processing configuration changing component that changes the processing configuration so as to realize transmission of the data signal within a predetermined cycle of the operating frequency using the instruction prefetch executing component when the data signal passes through the path of the critical path.

The processing configuration changing component may be configured to realize completion of transmission of the data signal within the predetermined cycle of the operating frequency by regulating the operating frequency using the instruction prefetch executing component when the data signal passes through the path of the critical path.

The processing configuration changing component may be configured to realize completion of transmission of the data signal within the predetermined cycle of the operating frequency by regulating a signal strength level correlated with the rise time of signal propagation using the instruction prefetch executing component when the data signal passes through the path of the critical path.

The signal strength level may be increase and decrease of a voltage.

The predetermined cycle may be one cycle.

As described above, according to the present invention, there can be obtained the effect that a malfunction resulting from a delay in a data signal on a critical path can be prevented.

What is claimed is:

1. A semiconductor integrated circuit device comprising:
an operating frequency generating component that generates an operating frequency that is a timing that becomes a reference for synchronizing processing between each circuit when the semiconductor integrated circuit operates;
an extracting component that extracts a critical path that is the slowest path when a data signal propagates between predetermined terminals inside the semiconductor integrated circuit;
an instruction prefetch executing component that prefetches an instruction relating to the critical path that has been extracted by the extracting component; and
a processing configuration changing component that changes the processing configuration so as to realize transmission of the data signal within a predetermined cycle of the operating frequency using the instruction prefetch executing component when the data signal passes through the path of the critical path.

2. The semiconductor integrated circuit device of claim 1, wherein the processing configuration changing component realizes completion of transmission of the data signal within the predetermined cycle of the operating frequency by regulating the operating frequency using the instruction prefetch executing component when the data signal passes through the path of the critical path.

3. The semiconductor integrated circuit device of claim 1, wherein the processing configuration changing component realizes completion of transmission of the data signal within the predetermined cycle of the operating frequency by regulating a signal strength level correlated with the rise time of signal propagation using the instruction prefetch executing component when the data signal passes through the path of the critical path.

4. The semiconductor integrated circuit device of claim 3, wherein the signal strength level is increase and decrease of a voltage.

5. The semiconductor integrated circuit device of claim 1, wherein the predetermined cycle is one cycle.

6. A critical path control method in a semiconductor integrated circuit device comprising:
(a) generating an operating frequency that is a timing that becomes a reference for synchronizing processing between each circuit when the semiconductor integrated circuit operates;
(b) extracting a critical path that is the slowest path when a data signal propagates between predetermined terminals inside the semiconductor integrated circuit;
(c) prefetching, with an instruction prefetch executing component, an instruction relating to the critical path that has been extracted; and
(d) changing the processing configuration so as to realize transmission of the data signal within a predetermined cycle of the operating frequency using the instruction prefetch executing component when the data signal passes through the path of the critical path.

7. The critical path control method of claim 6, wherein the method realizes completion of transmission of the data signal within the predetermined cycle of the operating frequency by regulating the operating frequency using the instruction prefetch executing component when the data signal passes through the path of the critical path.

8. The critical path control method of claim 6, wherein the method realizes completion of transmission of the data signal within the predetermined cycle of the operating frequency by regulating a signal strength level correlated with the rise time of signal propagation using the instruction prefetch executing component when the data signal passes through the path of the critical path.

9. The critical path control method of claim 8, wherein the signal strength level is increase and decrease of a voltage.

10. The critical path control method of claim 8, wherein the predetermined cycle is one cycle.
